(19) United States
(12) Patent Application Publication
(10) Pub. No.: US 2023/0288877 A1
(43) Pub. Date: Sep. 14, 2023

(54) DEVICE FOR GUIDING A SHAFT OF A SPRUNG BALANCE

(71) Applicant: ETA SA Manufacture Horlogère Suisse, Grenchen (CH)

(72) Inventors: Thierry CONUS, Lengnau (CH); Raphaël Courvoisier, Corcelles (CH); Jean-Luc Helfer, Le Landeron (CH); Sylvain Huot-Marchand, Eschert (CH)

(73) Assignee: ETA SA Manufacture Horlogère Suisse, Grenchen (CH)

(21) Appl. No.: 18/169,957

(22) Filed: Feb. 16, 2023

(30) Foreign Application Priority Data
Mar. 11, 2022 (EP) 22161630.3

(51) Int. Cl. G04B 31/012; G04B 17/32

(52) U.S. Cl. CPC G04B 31/012; G04B 17/32

(57) ABSTRACT

A device (1) for guiding a rotary shaft (6) of a sprung balance. The device includes at least the rotary shaft and a guide bearing (2) for guiding an end of the rotary shaft of the sprung balance, the guide bearing including at least one blade (3) and a surface (5) for coming into contact with and holding the end of the rotary shaft of the sprung balance. At least one end part of the shaft and at least the blade and the contact surface of the guide bearing are made of a material with a Young's modulus of less than or equal to 100 GPa and to reduce the coefficient of friction of the contacting parts.

### CROSS REFERENCE TO RELATED APPLICATIONS

This application claims priority to European Patent Application No. 22161630.3 filed Mar. 11, 2022, the entire contents of which are incorporated herein by reference.

### TECHNICAL FIELD

The invention relates to a device for guiding a rotary shaft of a sprung balance of a timepiece.

The invention further relates to a horological movement and a timepiece respectively comprising such a device for guiding a rotary shaft of a sprung balance.

### TECHNOLOGICAL BACKGROUND

Use of a sprung balance constituting a mechanical oscillator is known in the horological field, the oscillation frequency of which mechanical oscillator can be adjusted electronically or mechanically by a going train connected to a barrel system. The pivot at one end of the shaft can be guided generally by passing through a circular guide opening but with a certain degree of play. Under these conditions, positioning is seen to be rather imprecise and a high level of friction is observed, which is dependent on the position of the watch, which is capable of quickly causing wear to said pivot and of altering the chronometric precision of the watch, which is a drawback.

The Swiss patent document No. 239 786 discloses a device for guiding a pivot at one end of the rotary shaft of a sprung balance. The device is arranged with an olive stone and a stop that is inclined relative to the shaft of the balance. The shaft is guided without any play. Friction is thus independent of the position of the watch. In a horizontal position of the watch, the additional friction of the cylindrical part of the pivot against the olive stone is thus similar to that experienced in a vertical position. However, the amplitude is lower for all positions, which is a drawback in terms of precision control.

The production of a rotary shaft of a sprung balance made of a ceramic material is also known from the European patent document No. 3 258 325 B1 and Swiss patent document No. 269 552, which aims to prevent wear from occurring too quickly at the ends of the rotary shaft in a guide member.

The European patent document No. 3 382 472 A1 discloses a guide bearing for a pivot of a rotary shaft of a sprung balance of a timepiece. A guide bearing can be provided on either side of the ends of the rotary shaft. In one embodiment, the guide bearing can consist of three evenly spaced, spiral-shaped, curved blades, a first end of each blade whereof is fastened to a ring coaxial with the rotary shaft, whereas a second end of each blade comes into contact with one end of the rotary shaft of the balance to hold it radially. The guide bearing is made of a metal material. The guide bearing made of a metal material does not sufficiently reduce the forces when in contact with the shaft or with the pivot on the shaft. Under these conditions, there is too much energy loss, mainly due to friction with the end of the pivot or of the rotary shaft, even if the friction is no longer really dependent on the orientation of the watch, which is a drawback.

### SUMMARY OF THE INVENTION

The main purpose of the invention is thus to overcome the drawbacks of the prior art by providing a device for guiding a rotary shaft of a sprung balance with limited play of the shaft due to gravity and with the contact parts of the guide member having a material and geometry that are selected so as to reduce the bearing forces and thus the friction forces.

To this end, the invention relates to a device for guiding a rotary shaft of a sprung balance, which comprises the features defined in the independent claim 1.

Specific embodiments of the device for guiding a rotary shaft of a sprung balance are also described in the dependent claims 2 to 13.

Advantageously, at least the contacting parts of the shaft, or of a pivot fastened to the shaft, and of a guide bearing for the shaft are:
made of a material with a Young's modulus of less than or equal to 100 GPa so as to reduce friction forces, and/or
made with, or coated with, materials having a coefficient of friction therebetween of less than 0.15, or 0.1, or even 0.05.

Preferably, the material can be ceramic or glass or also a filled or non-filled polymer, to produce in particular the one or more blades for guiding and holding the guide bearing of the device in contact with one end of the rotary shaft of the sprung balance or of the end pivot of the rotary shaft. In addition to the material selected, a machining precision within a defined tolerance range must still be obtained. The geometry of the one or more blades can also be adapted so as to minimise the area in contact with the end of the shaft or of the pivot on the shaft.

The invention further relates to a horological movement comprising such a device as defined in claim 14.

The invention further relates to a timepiece comprising such a device as defined in claim 15.

### BRIEF DESCRIPTION OF THE FIGURES

The aims, advantages and features of a device for guiding a rotary shaft of a sprung balance will appear more clearly in the following description, in particular with reference to the drawings in which:

FIGS. 1a and 1b show a three-dimensional view from above of a sprung balance with the device for guiding the rotary shaft of the sprung balance, and a vertical side view of the sprung balance with the device for guiding the rotary shaft according to the invention,

FIG. 2 shows a simplified top view of a first embodiment of a guide bearing of the device for guiding the rotary shaft according to the invention, and

FIG. 3 shows a simplified top view of a second embodiment of a guide bearing of the device for guiding the rotary shaft according to the invention.

### DETAILED DESCRIPTION OF THE INVENTION

In the following description, all components or elements of the device for guiding a rotary shaft of a sprung balance are generally known. These elements or components will thus only be described briefly. It should firstly be noted that the device for guiding a rotary shaft of the sprung balance further comprises said shaft which forms a part of a whole with the guide elements of this shaft and means to avoid the effect of gravity. It goes without saying that mention can also be made of an assembly comprising at least one guide bearing and the rotary shaft of the sprung balance to define the device for guiding a rotary shaft of the sprung balance.

In the following description of the device for guiding a rotary shaft of a sprung balance, a guide bearing can be provided, which can consist of contact parts such as flexible blades for example for positioning the axis of the sprung balance. This in particular limits the parasitic motions of the sprung balance when the movement is in a horizontal position. In general, the motions generated are responsible for chronometric errors. In one embodiment with the flexible blades, these blades have a centring effect on the axis of rotation of the sprung balance.

The friction forces between horizontal and vertical positions of the horological movement can also be balanced according to the invention. Friction losses are generally responsible for decreases in amplitude and thus for differences in chronometric rate due to the intrinsic anisochronism of the sprung balance system. If equivalent losses are observed regardless of the horizontal or vertical position, a good precision is obtained for the movement, regardless of the spatial position thereof.

According to the present invention, a pivot system in a closed space can also be conceived, allowing a lubricant to be used, in contrast to that described in the prior art, where a so-called open system is used, which is generally incompatible with lubrication. An added lubricant minimises friction losses, which has the advantage of allowing guide bearing blades to be incorporated, which can be stiffer but also easier to handle when assembling the components.

As will be described hereinbelow according to the present invention, the use of components made of polymer materials is advantageous. These components are, for example, produced for flexible or resilient blades in a guide bearing, or also for coating contact parts of such guide bearings. Instead of flexible or resilient blades or contact parts, an elastomer with friction surfaces made of a material that is better adapted for friction with adequate inserts can also conceivably be used.

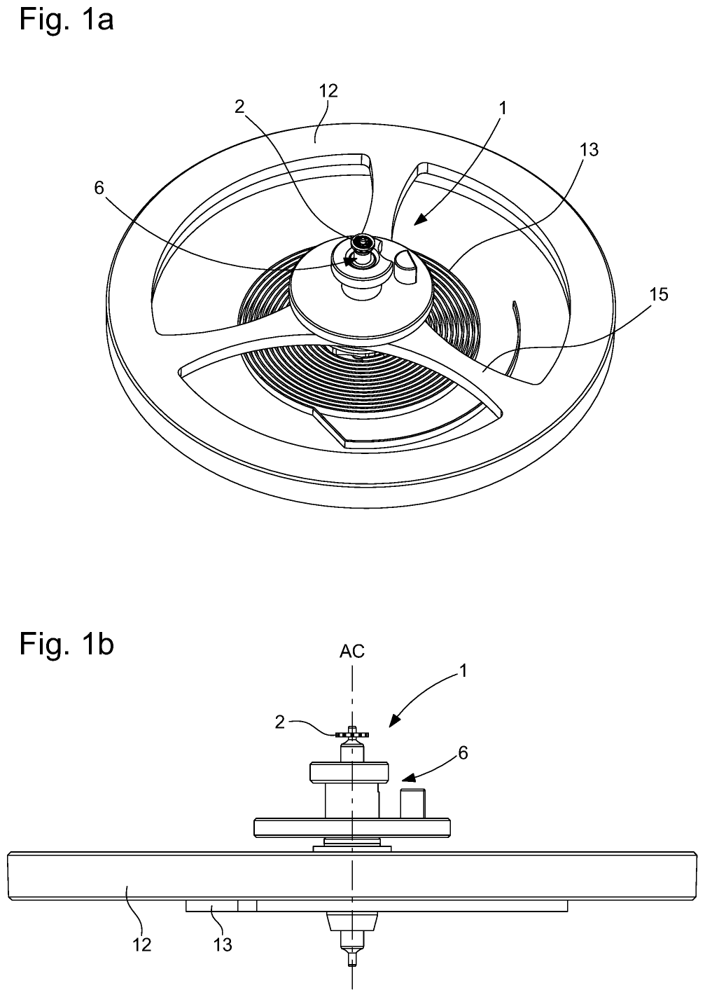

FIGS. 1a and 1b show the sprung balance with the device 1 for guiding the rotary shaft 6 assembly of said sprung balance. The sprung balance is formed by a rim 12 connected, for example, by three arms 15 to a central rotary shaft 6, and a balance spring 13, having a first end connected to a stud (not shown) of a cock of the balance. A second end of the balance spring 13 is fastened directly, or indirectly via a collet, to the rotary shaft 6 of the sprung balance.

The device 1 for guiding the rotary shaft 6 of the sprung balance comprises said rotary shaft 6 and at least one guide bearing 2 preferably disposed at one end of the rotary shaft 6. It goes without saying that two guide bearings 2 for the rotary shaft disposed at the two ends of the rotary shaft can be considered, in particular to centre the rotary shaft 6 along the central axis AC.

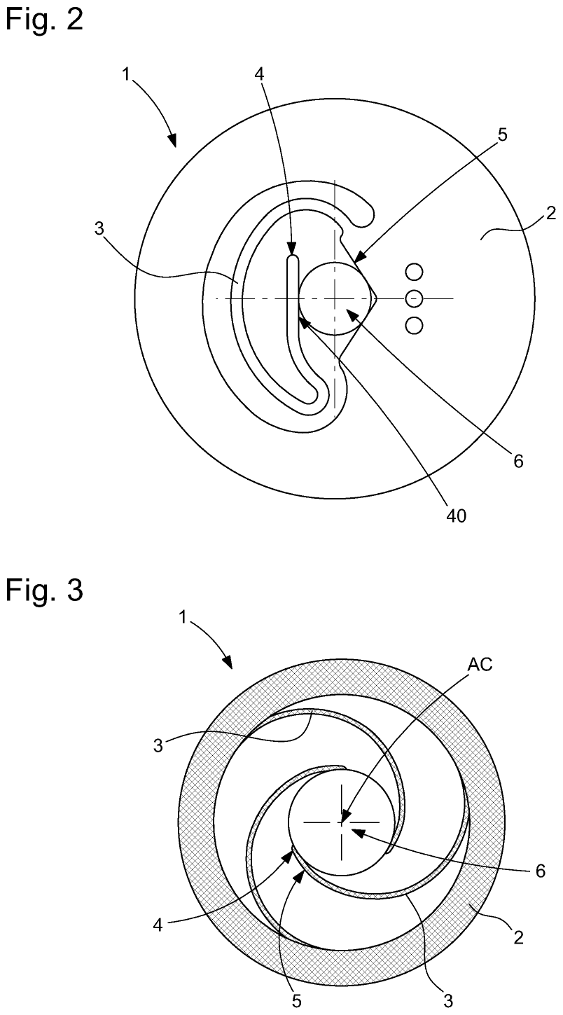

The guide bearing 2 can advantageously be mounted at an upper end of the rotary shaft 6, for example on the dial side. However, two guide bearings 2 respectively mounted at each end of the rotary shaft 6 can be considered. Each guide bearing 2, described in more detail with reference to FIGS. 2 and 3 hereinbelow, comprises contact parts for coming into contact with and holding the ends of the rotary shaft or of end pivots of the rotary shaft, since the rotary shaft connected to the sprung balance is always undergoing an alternating rotary motion in normal operation relative to the guide bearing 2, which is fixedly mounted in or on an adjustment member (not shown).

At least all of the contacting parts of the guide bearing 2 and of the rotary shaft 6 or with the end pivot of the rotary shaft are advantageously made of a material with a modulus of elasticity (Young's modulus) of less than or equal to 100 GPa and/or with a coefficient of friction as low as possible, for example at least less than or equal to 0.15. Preferably, the material can be selected from ceramic, glass or a filled or non-filled polymer, and a list of these materials will be given in more detail in the second part of the detailed description.

FIG. 2 shows a first embodiment of the guide bearing 2 for guiding the rotary shaft 6 connected to the sprung balance. The overall shape of the guide bearing 2 is peripherally cylindrical overall so as to be housed and fastened inside an opening in a setting or mounting plate (not shown). In a central part of the guide bearing 2, where the guiding and holding of the rotary shaft 6 will take place, at least one guide blade 3 is provided for contact, at one of the ends 4 thereof, with the rotary shaft 6 or on a part added to the rotary shaft, which can be a pivot.

According to the invention in this first embodiment, at least one guide bearing 2 includes, on a first side of the central axis AC, a support part 5, which is a support surface 5 of any geometric shape adapted to make a single contact point or a contact line with the rotary shaft 6 or the pivot mounted on the rotary shaft. The support surface can also be V-shaped or a bearing, or the like, and is arranged to centre the axis of rotation of a shaft 6 on a bisecting plane of the support surface 5. This support surface 5 is symmetrical. The same guide bearing 2 includes, on a second side of the axis of revolution, which is opposite the first side, at least one holding element 4 at the free end of the blade 3, which is disposed substantially diametrically opposite the support surface 5. It is understood that the support surface 5, which is symmetrical relative to the bisecting plane thereof, includes two elementary support surfaces, in this case a V-shaped surface.

According to the invention, all the holding elements 3, 4 for holding contact with the contact surface 40 are arranged to exert a resultant resilient return force, on a shaft 6, directed towards the central axis AC, and to prevent a shaft 6 inserted axially in the direction of the axis of revolution in this guide bearing 2 from radially exiting this guide bearing 2.

However, it should be noted that a single blade 3 with a contact surface 40 to hold the rotary shaft against the V-shaped surface 5 is difficult to produce because, depending on the orientation of the timepiece, the sprung balance is too heavy to be held by the sole blade provided.

In FIGS. 2 and 3, the blade 3, up to the free end thereof, has a rectangular cross-section so as to have a planar contact portion 40 in contact with the end of the shaft 6 or of the pivot 6′ on a contact line. Alternatively, at least the free end of the blade 3 has a lenticular cross-sectional geometry so as to have only one contact point on the portion 40 to reduce friction when in contact with the end of the rotary shaft 6 or of the pivot mounted on the rotary shaft 6.

It should be noted that contact between the shaft 6 or the pivot and one or more support parts 5 in the form of a point or line of contact can be conceived. In the case of a contact point, each support part 5 can be made, for example, in the form of a domed structure or a ball portion. However, many other structures can be conceived in order to procure such a contact point. For a contact along a contact line, this can also be a cylindrical portion or structure of a support part disposed along an axis parallel to the axis of rotation of the rotary shaft or of any other structure. A combination of a contact point or contact line can be conceived. Moreover, any geometric shape can be proposed to make a contact point or contact line with the rotary shaft or the pivot mounted on the rotary shaft.

For further information on this first embodiment, reference can be made to the Swiss patent application No. 716 957 A2, in particular from paragraph [0021] to paragraph [0027], which describes guide bearings for a time indicator shaft.

FIG. 3 shows a second embodiment of the guide bearing 2 of the device 1 for guiding the rotary shaft 6 of the sprung balance. This guide bearing 2 can comprise at least one contact blade 3 and two support parts 5, which are preferably two further contact blades 3. Thus, the guide bearing 2 is composed of a peripheral ring and of three blades 3 in the form of coils in order to move towards the rotary shaft 6 to come into contact with the rotary shaft 6 and hold and guide it along the central axis AC. The free end 4 of each blade 3 comes into direct contact with the rotary shaft 6 to hold, centre and guide it along the central axis AC. The three blades 3 can be of a different shape than the coils and have a cross-section that is not rectangular. For example, each blade is rectilinear, angularly disposed and evenly spaced 120° from one another in order for each to contact the rotary shaft in a homogeneous manner. More than three blades making contact with the rotary shaft can also be conceived.

The guide bearing 2 of this second embodiment can be obtained in one piece from a ceramic, glass or filled or non-filled polymer material, in particular below the threshold limit of the modulus of elasticity of less than or equal to 100 GPa and/or with the lowest possible coefficient of friction, for example less than or equal to 0.15. Moreover, the part of the rotary shaft 6 in contact with parts of the guide bearing 2 are made of the same or of a different material or coating fulfilling the conditions defined by the modulus of elasticity threshold or having the lowest possible coefficient of friction, for example at least less than or equal to 0.15.

For further information on this second embodiment, reference can be made to the European patent application No. 3 396 470 A1, from paragraph [0018] to paragraph [0022].

The type of ceramics to be used for the guide bearing and/or the rotary shaft can be oxide-based ceramics, mainly alumina and zirconia, or silica.

Zirconium oxide (ZrO₂) can be used in yttria-stabilised zirconias (ZrO₂+Y₂O₃), which have a metastable tetragonal crystal structure, a grain size of less than 0.50 μm, a density of greater than 6.00 g/cm³ and a hardness of about 1,200 HV. Zirconias can also be stabilised with cerium oxide (ZrO₂+CeO₂) or magnesium oxide (ZrO₂+MgO), depending on the properties of the desired final material.

With regard to Zirconia Alumina, composites are generally 80% 3Y-TZP/20% Al₂O₃(ATZ) or 90% Al₂O₃/10% 3Y-TZP (ZTA), combining the properties of high-purity zirconias and aluminas to procure final properties that offer the best of each material.

It should also be noted that the use of hard materials allows the contact friction forces of the contacting materials to be lowered or reduced, which can also be sought after.

Based on the description which has just been given, multiple alternative embodiments of the device for guiding a rotary shaft of a sprung balance can be conceived by a person skilled in the art without departing from the scope of the invention defined by the claims.

1. A device (1) for guiding a rotary shaft (6) of a sprung balance, comprising:
the rotary shaft; and
a guide bearing for guiding an end or a pivot fastened to an end of the rotary shaft of the sprung balance, the guide bearing comprising a blade and a support part for corning into contact with and holding the end or the pivot of the rotary shaft of the sprung balance,
wherein an end part of the rotary shaft or of the pivot, or the contact parts of the guide bearing are made of a material with a Young's modulus of less than or equal to 100 GPa and/or with a coefficient of friction of the materials of the contacting parts or of the coating of the contacting parts of less than or equal to 0.15.

2. The device according to claim 1, wherein the support part is a support surface of any geometric shape adapted to make a single contact point or a contact line with the rotary shaft or the pivot mounted on the rotary shaft.

3. The device according to claim 1, wherein the support part is a support surface.

4. The device according to claim 1, wherein two support parts include contact blades so as to have three contact blades in order to centre the axis of rotation of the sprung balance.

5. The device according to claim 4, wherein the device includes three contact blades, each of said three blades being coil-shaped, and in that a first end of each blade is fastened to a ring coaxial with the rotary shaft, whereas a second end of each blade comes into contact with one end of the rotary shaft of the balance to hold it axially.

6. The device according to claim 4, wherein each of the contact blades are rectilinear in shape, and wherein a first end of each blade is fastened to a ring coaxial with the rotary shaft, whereas a second end of each blade comes into contact with one end of the rotary shaft of the balance to hold it axially.

7. The device according to claim 5, wherein all of the blades are evenly spaced 120° apart from one another around the ring.

8. The device according to claim 1, wherein at least one blade or a support part comprises a contact portion making contact with the shaft or the pivot and formed so as to have only a single point of contact with the shaft or the pivot.

9. The device according to claim 1, wherein each blade comprises a contact portion making contact with the shaft or the pivot and formed so as to have only a single point of contact in order to reduce friction.

10. The device according to claim 1, wherein a contact part of the shaft, the contact blade and the support part are made of the same ceramic, glass or filled or non-filled polymer material.

11. The device according to claim 1, wherein a contact part of the shaft, the contact blade and the support part of the guide bearing are made of two different ceramic, glass or filled or non-filled polymer materials.

12. The device according to claim 10, wherein the elements of the guide bearing are made in one piece.

13. The device according to claim 1, wherein the coefficient of friction of the materials of the contacting parts or of the coating of the contacting parts is at least less than or equal to 0.1, or at least less than or equal to 0.05, or at least an end part of the shaft or of the pivot or at least the contact parts of the guide bearing are made of a material with a Young's modulus of less than or equal to 100 GPa.

14. A timepiece movement equipped with the device according to claim 1.

15. A timepiece provided with a movement equipped with the device according to claim 1.
